(19) United States
(12) Patent Application Publication
(10) Pub. No.: US 2007/0034467 A1
(43) Pub. Date: Feb. 15, 2007

(54) Hydraulic brake device

(75) Inventor: Che-Wen Lien, Taipei City (TW)

Correspondence Address: LEONG C LEI, PMB # 1008, 1867 YGNACIO VALLEY ROAD, WALNUT CREEK, CA, 94598, US

(73) Assignee: CHINA FINEBLANKING TECHNOLOGY CO., LTD.

(21) Appl. No.: 11/203,172

(22) Filed: Aug. 15, 2005

(51) Int. Cl. B60T 11/00

(52) U.S. Cl. 188/344

(57) ABSTRACT

A hydraulic brake device is disclosed. The device has a seat body mounted with a left-right sliding piston structure and a handle at one side of the seat body for actuating the piston structure, the seat body having a piston cavity and an oil supplementing cavity arranged adjacent to each other, an oil-supplying hole connecting the piston cavity and the oil-supplementing cavity, the piston structure includes a hollow piston cavity body and a push rod connected to the handle, an oil space corresponding to the oil-supplying hole is formed between the outer edge of the hollow piston cavity body and the inner wall of the piston cavity, and the piston cavity body is provided with a cavity hole for the insertion of the push rod and the circumferential edge of the piston cavity body is provided with a through hole communicating the oil cavity and the cavity hole, the rear end of the cavity hole is locked with a cavity cover body allowing the push rod to pass through, the circumferential edge of the cavity body is an engaging circular cavity with a sealing element, the front end of the piston cavity body is an oil delivery hole linked to the front end of the piston cavity, and the circumferential edge of the front end is an engaging ring cavity with a sealing member, and in between the inner wall of the front end of the piston cavity and the piston cavity body, a restoration spring is supported, and one end of the push rod is a piston head with a larger radius and the external edge of the piston head is an engaging ring slot for mounting with the sealing member, the front end of the push rod within the piston head is protruded with a plug head and the plug head can stop the oil delivery hole, and in between the push rod and the inner wall at the front end of the cavity hole of the cavity body, a restoration spring is supported.

### BACKGROUND OF THE INVENTION

(a) Technical Field of the Invention

The present invention relates to hydraulic brake device, and in particular, to a brake device employing a push rod linked to a pulling handle to stop oil supplementary cavity and piston cavity within the seat body of the hydraulic brake device.

(b) Description of the Prior Art

FIG. 1 shows a conventional brake device 10 having seat body 11 including a piston cavity 12 and an oil-supplementary cavity 11 and a piston 16. This conventional brake device can function normally in braking, however, in case continuously braking is required, as shown in FIGS. 1 and 2, the first depression of handle 20, the piston 16 is pushed to the bottom until a braking action is completed, and when the handle 20 is released, the piston 16 is restored by the restoration spring 19. But the oil, which is pushed to the braking block cannot fully return to the piston cavity 12, and the diameter of the oil-supplying hole 14 is limited and oil supply cannot be achieved. Thus, if the user presses the handle 20 again, the oil of the hydraulic device of the piston cavity cannot fully restore and therefore the braking effect is poor. Further, oil cannot be refurnished. This will affect the safety of driving.

Accordingly, it is an object of the present invention to provide a hydraulic brake device, which mitigates the above drawback.

### SUMMARY OF THE INVENTION

The primary purpose of the present invention is to provide a hydraulic brake device having a seat body mounted with a left-right sliding piston structure and a handle at one side of the seat body for actuating the piston structure, the seat body having a piston cavity and an oil supplementing cavity arranged adjacent to each other, an oil-supplying hole connecting the piston cavity and the oil-supplementing cavity, characterized in that the piston structure includes a hollow piston cavity body and a push rod connected to the handle, an oil space corresponding to the oil-supplying hole is formed between the outer edge of the hollow piston cavity body and the inner wall of the piston cavity, and the piston cavity body is provided with a cavity hole for the insertion of the push rod and the circumferential edge of the piston cavity body is provided with a through hole communicating the oil cavity and the cavity hole, the rear end of the cavity hole is locked with a cavity cover body allowing the push rod to pass through, the circumferential edge of the cavity body is an engaging circular cavity with a sealing element, the front end of the piston cavity body is an oil delivery hole linked to the front end of the piston cavity, and the circumferential edge of the front end is an engaging ring cavity with a sealing member, and in between the inner wall of the front end of the piston cavity and the piston cavity body, a restoration spring is supported, and one end of the push rod is a piston head with a larger radius and the external edge of the piston head is an engaging ring slot for mounting with the sealing member, the front end of the push rod within the piston head is protruded with a plug head and the plug head can stop the oil delivery hole, and in between the push rod and the inner wall at the front end of the cavity hole of the cavity body, a restoration spring is supported.

Yet still another object of the present invention is to provide a hydraulic brake device, wherein the external edge of the piston cavity is a tapered edge such that in between the cavity body and the inner wall of the piston cavity, an oil cavity corresponding to the oil delivery hole is provided.

A further object of the present invention is to provide a hydraulic brake device, wherein the end of the inner wall of the cavity hole has a threaded section and the front section of the cover body is a threaded section for the cover body to be screwed to the cavity hole.

Still a further object of the present invention is to provide a hydraulic brake device, wherein the push rod between the piston head and the external edge of the piston head is an engaging ring slot and the engaging ring slot is a sealing member so as to block the oil delivery hole.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view of a conventional hydraulic brake device.

FIG. 2 is a schematic view of the conventional hydraulic brake device.

FIG. 3 is an exploded perspective view of the present invention hydraulic brake device.

FIGS. 4A and 4B is a sectional view of the present invention hydraulic brake device.

FIGS. 5A and 5B is a schematic view of the interruption of the oil delivery hole.

FIG. 6 is a schematic view showing the braking action of the hydraulic brake device.

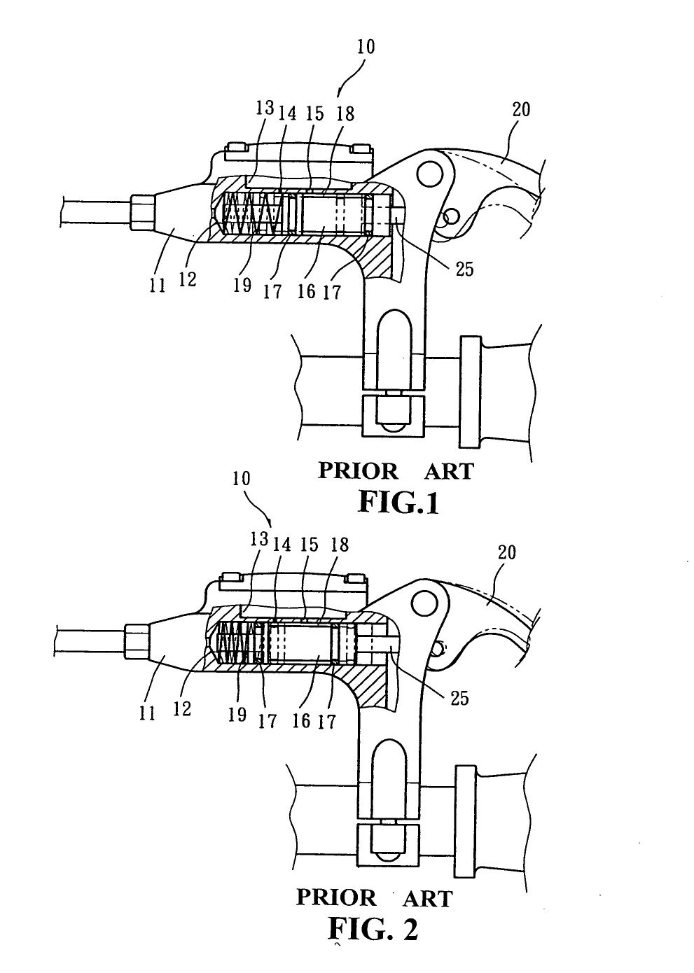

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

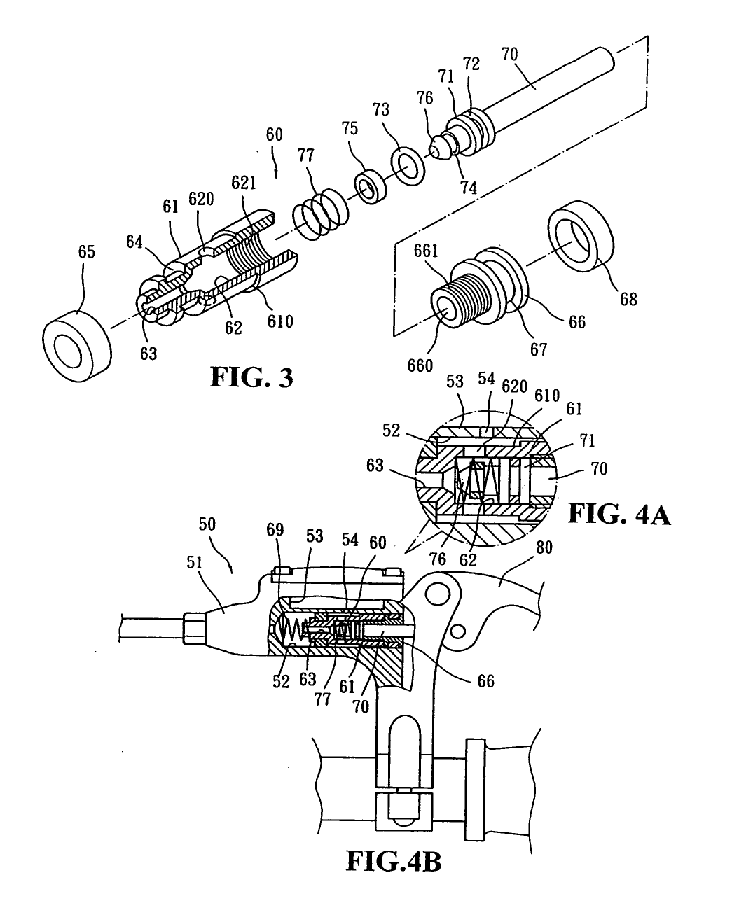

Referring to FIGS. 3, 4A and 4B, there is shown the hydraulic brake device 50 including a seat body 51 mounted onto a handle and a piston structure 60 slide-mounted to the seat body 51. The piston structure 60 includes a hollow piston cavity 61 and a push rod 70 linked to a handle. The external edge of the piston cavity body 61 is tapered edge 610 such that an oil cavity of an oil hole 54 is formed between the piston cavity body 61 and the inner wall of the piston cavity 52 of the seat body 51. The piston cavity 61 is a cavity hole 62 for a push rod 70 to pass through. The circumferential edge of the piston cavity body 61 is a through hole 620 linked to the cavity hole 62 and the oil cavity, and the end of the inner wall of the cavity hole 62 is a threaded section 621 for locking by a cavity cover body 66. The front end of the piston cavity body 61 is an oil-delivering hole 63 linked to the piston cavity 52.

The outer edge of the front end of the piston cavity body 61 is an engaging ring slot 64 having a sealing member 65 urging the inner wall of the piston cavity 52. The external edge of the cavity cover body 66 is mounted with an engaging ring slot 67 having a sealing member 68.

The piston cavity body 61 makes use of the sealing members 65, 68 at the two ends to isolate the piston cavity 52 and the oil cavity. Further, the center of the cover body 66 is a through hole 660 allowing a push rod 70 to pass through such that the piston cavity body 61 slides along the push rod 70. The front end of the cavity covering body 66 is a threaded section 661 allowing the cavity cover body 66 to be locked to the threaded section 621. Further, between the inner wall of the front end of the piston cavity 52 and the front end of the piston cavity body 61, a restoration spring 69 is formed, and the piston structure 66 can automatically restore to its original position.

One end of the push rod 70 within the piston cavity body 61 is a piston head of larger diameter, and the external edge of the piston head 71 is an engaging slot 72 for mounting with a sealing member 73. The external edge of the sealing member 73 urges the inner wall of the cavity hole 62 of the piston cavity body 61, and the push rod 70 at the front end of the piston head 71 is a conic plug head 76 which can stop oil delivery hole 63 of the piston cavity body 61. Further, the push rod 70, at the external edge between the piston head 71 and the piston head 76 is an engaging slot 74. The engaging slot 74 is mounted with a sealing member 75 so as to enhance the interruption of the oil-delivering hole 63. Further, between the front end of the push rod 70 and the inner wall of the front end of the cavity hole 62 is a restoration spring allowing the push rod 70 to restore to its original position when the handle 80 is released.

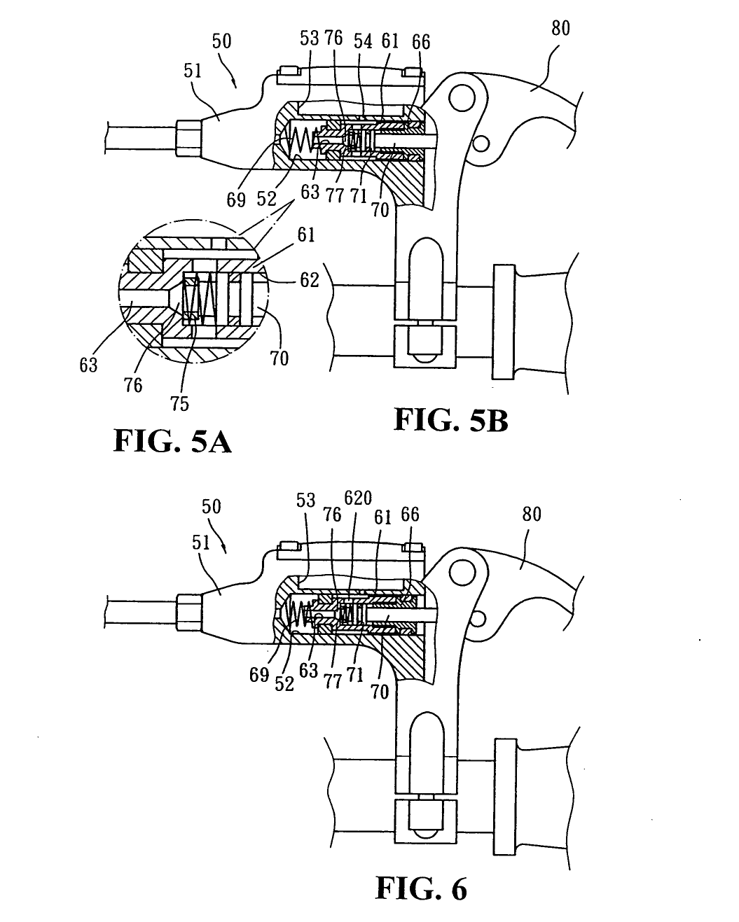

FIGS. 4A, 4B, 5A, 5B and 6 show the hydraulic brake device 50 retreating to the rear end of the piston cavity 52 before braking. Further, the push rod 70 is also retreated to urge the cavity cover body 66 (as shown in FIGS. 4A and 4B). When the handle 80 is pressed in braking, the handle 80 pushes the rod 70 forward such that the piston head 76 urges the inner edge of the cavity hole 62. The sealing member 75 interrupts the oil delivery hole 63 (as shown in FIGS. 5A and 5B), and pushed forward the piston cavity body 61, so as to push forward the oil within the piston cavity 52 (as shown in FIG. 6) and a braking effect is provided.

When the handle 80 is released, the piston structure 60 and the push rod 70 are restored to their respective position by the restoration spring 69 and the restoration spring 77 (as shown in FIGS. 4A and 4B). The oil material within the oil-supplementary cavity 53 will fill the piston cavity 52 via the oil delivering hole 63, and when a further braking is required, the user will press a second time the handle 80, the push rod 70 is pushed forward, and the piston head 76 of the push rod 70 interrupts the oil delivery hole 63 so as to balance the hydraulic pressure of the piston cavity 52 and a braking effect is obtained.

In view of the above, the brake device enhances the safety of braking.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hydraulic brake device having a seat body mounted with a left-right sliding piston structure and a handle at one side of the seat body for actuating the piston structure, the seat body having a piston cavity and an oil supplementing cavity arranged adjacent to each other, an oil-supplying hole connecting the piston cavity and the oil-supplementing cavity, characterized in that
the piston structure includes a hollow piston cavity body and a push rod connected to the handle, an oil space corresponding to the oil-supplying hole is formed between the outer edge of the hollow piston cavity body and the inner wall of the piston cavity, and the piston cavity body is provided with a cavity hole for the insertion of the push rod and the circumferential edge of the piston cavity body is provided with a through hole communicating the oil cavity and the cavity hole, the rear end of the cavity hole is locked with a cavity cover body allowing the push rod to pass through, the circumferential edge of the cavity body is an engaging circular cavity with a sealing element, the front end of the piston cavity body is an oil delivery hole linked to the front end of the piston cavity, and the circumferential edge of the front end is an engaging ring cavity with a sealing member, and in between the inner wall of the front end of the piston cavity and the piston cavity body, a restoration spring is supported, and one end of the push rod is a piston head with a larger radius and the external edge of the piston head is an engaging ring slot for mounting with the sealing member, the front end of the push rod within the piston head is protruded with a plug head and the plug head can stop the oil delivery hole, and in between the push rod and the inner wall at the front end of the cavity hole of the cavity body, a restoration spring is supported.

2. The hydraulic brake device of claim 1, wherein the external edge of the piston cavity is a tapered edge such that in between the cavity body and the inner wall of the piston cavity, an oil cavity corresponding to the oil delivery hole is provided.

3. The hydraulic brake device of claim 1 or 2, wherein the end of the inner wall of the cavity hole has a threaded section and the front section of the cover body is a threaded section for the cover body to be screwed to the cavity hole.

4. The hydraulic brake device of claim 1, wherein the push rod between the piston head and the external edge of the piston head is an engaging ring slot and the engaging ring slot is a sealing member so as to block the oil delivery hole.
